(19) United States
(12) Patent Application Publication
(10) Pub. No.: US 2006/0184363 A1
(43) Pub. Date: Aug. 17, 2006

(54) Noise suppression

(76) Inventors: Alan McCree, Acton, MA (US); Takahiro Unno, Richardson, TX (US)

Correspondence Address: TEXAS INSTRUMENTS INCORPORATED, P O BOX 655474, M/S 3999, DALLAS, TX, 75265, US

(21) Appl. No.: 11/356,800

(22) Filed: Feb. 17, 2006

Related U.S. Application Data
(60) Provisional application No. 60/654,555, filed on Feb. 17, 2005.

(51) Int. Cl. G10L 15/20

(52) U.S. Cl. 704/233

(57) ABSTRACT

Noise suppression (speech enhancement) by spectral amplitude filtering using a gain determined with a quantized estimated signal-to-noise ratio plus, optionally, prior frame suppression. The relation between signal-to-noise ratio and filter gain derives from a codebook mapping with a training set constructed from clean speech and noise conditions.

### CROSS-REFERENCE TO RELATED APPLICATIONS

This application claims priority from provisional patent application No. 60/654,555, filed Feb. 17, 2005.

### BACKGROUND OF THE INVENTION

The present invention relates to digital signal processing, and more particularly to methods and devices for noise suppression in digital speech.

Speech noise suppression (speech enhancement) is a technology that suppresses a background noise acoustically mixed with a speech signal. A variety of approaches have been suggested, such as “spectral subtraction” and Wiener filtering which both utilize the short-time spectral amplitude of the speech signal. Further, Ephraim et al, Speech Enhancement Using a Minimum Mean-Square Error Short-Time Spectral Amplitude Estimator, 32 IEEE Tran. Acoustics, Speech, and Signal Processing, 1109 (1984) optimizes this spectral amplitude estimation theoretically using statistical models for the speech and noise plus perfect estimation of the noise parameters.

U.S. Pat. No. 6,477,489 and Virag, Single Channel Speech Enhancement Based on Masking Properties of the Human Auditory System, 7 IEEE Tran. Speech and Audio Processing 126 (March 1999) disclose methods of noise suppression using auditory perceptual models to average over frequency bands or to mask in frequency bands.

These approaches demonstrate good performance; however, these are not sufficient for many applications.

### SUMMARY OF THE INVENTION

The present invention provides methods of noise suppression with a spectral amplitude adjustment based on codebook mapping from signal-to-noise ratio to spectral gain.

Preferred embodiment methods have advantages including good performance with low computational complexity.

### BRIEF DESCRIPTION OF THE DRAWINGS

FIGS. 1a-1b illustrate preferred embodiment noise suppression.

FIGS. 2-3 show preferred embodiment noise suppression lookup tables and curves.

FIG. 4 is a preferred embodiment lookup table construction.

### DESCRIPTION OF THE PREFERRED EMBODIMENTS

1. Overview

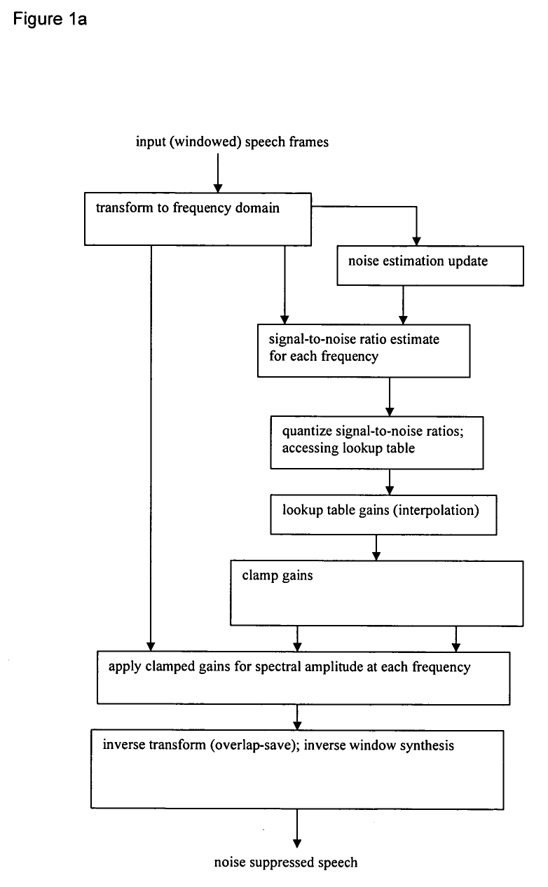

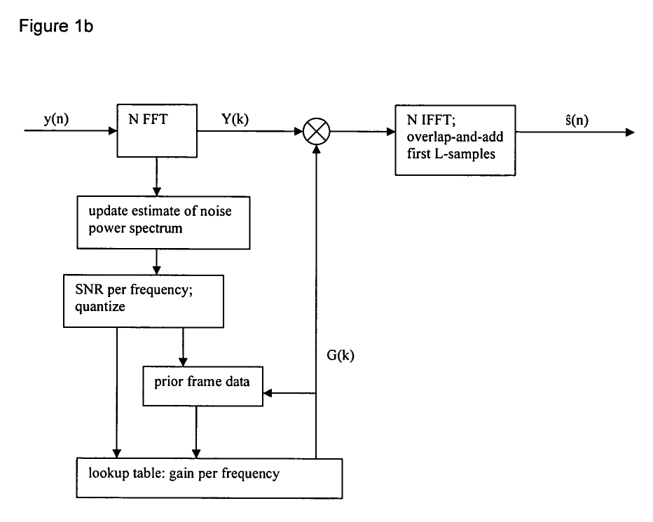

Preferred embodiment noise suppression (speech enhancement) methods include applying a frequency-dependent gain where the gain depends upon the estimated signal-to-noise ratio (SNR) for the frequency and a codebook mapping determines this SNR-to-gain relation. FIG. 1a illustrates a first preferred embodiment method which includes the steps of: (i) windowing noisy input speech; (ii) transforming to the frequency domain with an FFT; (iii) estimating a signal-to-noise ratio (SNR) for each frequency using a long-term noise estimator together with the transformed noisy speech; (iv) using a quantized SNR as an index to look up a frequency-dependent gain; (v) applying the frequency-dependent gain to the transformed noisy speech; (vi) inverse transforming to the time domain by IFFT; and (vii) synthesizing noise-suppressed speech by combining the windowed frames.

Alternative preferred embodiments modify this noise suppression by clamping the gain, smoothing the gain, and/or extending the lookup table to a second index to account for prior frame results as illustrated in FIG. 1b.

Preferred embodiment systems, such as cell phones (which may have voice recognition), in noisy environments perform preferred embodiment methods with digital signal processors (DSPs) or general purpose programmable processors or application specific circuitry or systems on a chip (SoC) such as both a DSP and RISC processor on the same chip. A program stored in an onboard ROM or external flash EEPROM for a DSP or programmable processor could perform the signal processing. Analog-to-digital converters and digital-to-analog converters provide coupling to the real world, and modulators and demodulators (plus antennas for air interfaces) provide coupling for transmission waveforms. The noisy speech can also be enhanced, encoded, packetized, and transmitted over networks such as the Internet.

2. First Preferred Embodiment Noise Suppression

First preferred embodiment methods of noise suppression (speech enhancement) use a frequency-dependent gain determined from estimated SNR by training data with a minimum mean-square error metric. In particular, presume a digital sampled speech signal, s(n), is distorted by additive background noise signal, w(n); then the observed noisy speech signal, y(n), can be written as:
y(n)=s(n)+w(n)
The signals are partitioned into frames (either windowed with overlap or non-windowed without overlap). Initially consider the simple case of N-point FFT transforms; following sections will include gain interpolations, smoothing over time, gain clamping, and alternative transforms.

N-point FFT input consists of M samples from the current frame and L samples from the previous frame where M+L=N. L samples will be used for overlap-and-add in the end.
Y(k, r)=S(k, r)+W(k, r)
where Y(k, r), S(k, r), and W(k, r) are the (complex) spectra of s(n), w(n), and y(n), respectively, for sample index n in frame r, and k denotes the frequency index in the range k=0, 1, 2, . . . , N−1 (these spectra are conjugate symmetric about the frequency (N−1)/2). Then the preferred embodiment estimates the speech by a scaling in the frequency domain:
Ŝ(k, r)=G(k, r)Y(k, r)
where Ŝ(k, r) is the noise-suppressed (enhanced speech) spectrum and G(k, r) is the noise suppression filter gain in the frequency domain. The preferred embodiment G(k, r) depends upon a quantization of ρ(k, r) where ρ(k, r) is the estimated input-signal signal-to-noise ratio (SNR) in the kth frequency index for the rth frame and Q indicates the quantization:
G(k, r)=lookup{Q(ρ(k, r))}
In this equation lookup{ } indicates the entry in the gain lookup table (constructed in the next section), and:
ρ(k, r)=|Y(k, r)|²/|Ŵ(k, r)|²
Ŵ(k, r) is a long-run noise spectrum estimate which can be generated in various ways. A preferred embodiment long-run noise spectrum estimation updates the noise energy for each frequency index, |Ŵ(k, r)|², for each frame by:

$${\vert \hat{W} ( k , r ) \vert}^{2} = \{ \begin{matrix}κ {\vert \hat{W} ( k , r - 1 ) \vert}^{2} & if {\vert Y ( k , r ) \vert}^{2} > κ {\vert \hat{W} ( k , r - 1 ) \vert}^{2} \\ λ {\vert \hat{W} ( k , r - 1 ) \vert}^{2} & if {\vert Y ( k , r ) \vert}^{2} < λ {\vert \hat{W} ( k , r - 1 ) \vert}^{2} \\ {\vert Y ( k , r ) \vert}^{2} & otherwise\end{matrix}$$

where, assuming noise level is updated once every 20 ms, κ=1.0139 (3 dB/sec) and λ=0.9462 (−12 dB/sec) are the upward and downward time constants, respectively, and |Y(k, r)|² is the signal energy for the kth frequency in the rth frame.

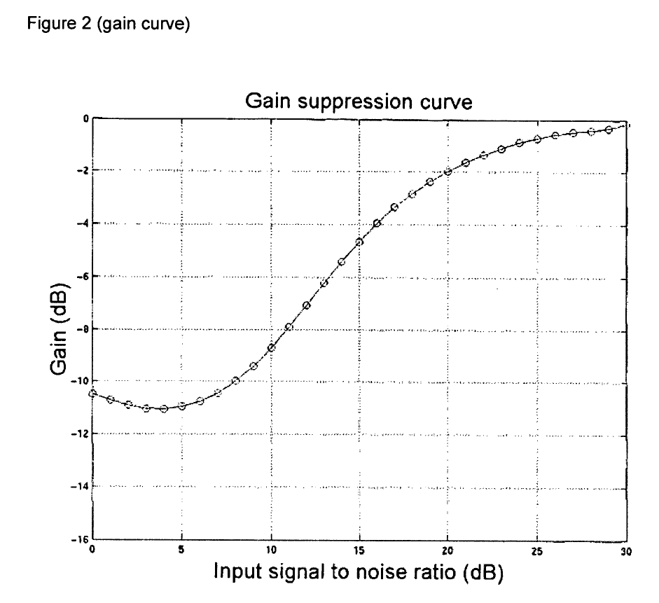

FIG. 2 illustrates a preferred embodiment noise suppression curve; that is, the curve defines a gain as a function of input-signal SNR. The thirty-one points on the curve (indicated by circles) define entries for a lookup table: the horizontal components (log ρ(k, r)) are uniformly spaced at 1 dB intervals and define the quantized SNR input indices (addresses), and the corresponding vertical components are the corresponding G(k, r) entries.

Thus the preferred embodiment noise suppression filter G(k, r) attenuates the noisy signal with a gain depending on the input-signal SNR, ρ(k, r), in each frequency. In particular, when a frequency has large ρ(k, r), then G(k, r)≈1 and the spectrum is not attenuated in this frequency. Otherwise, it is likely that the frequency contains significant noise, and G(k, r) tries to remove the noise power.

The preferred embodiment methods generate enhanced speech Ŝ(k, r) which has the same distorted phase characteristic as the noisy speech Y(k, r). This operation is proper because of the insignificance of the phase information of a speech signal.

Lastly, apply N-point inverse FFT (IFFT) to Ŝ(k, r), and use L samples for overlap-and-add to thereby recover the noise-suppressed speech, ŝ(n), in the rth frame; see FIG. 1a.

3. Codebook Mapping

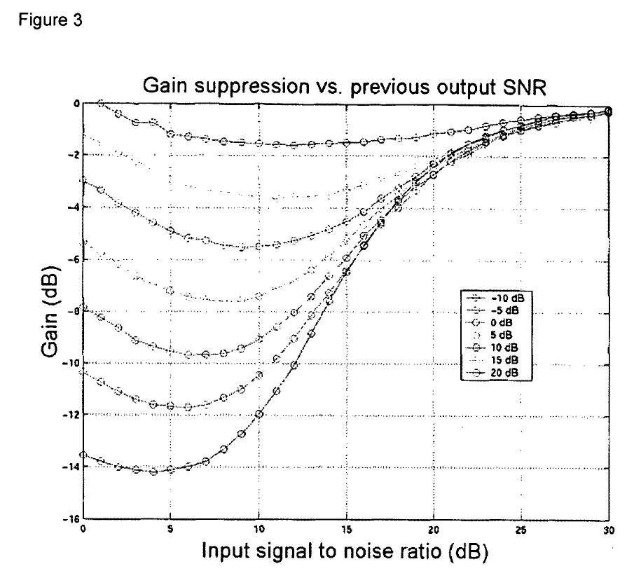

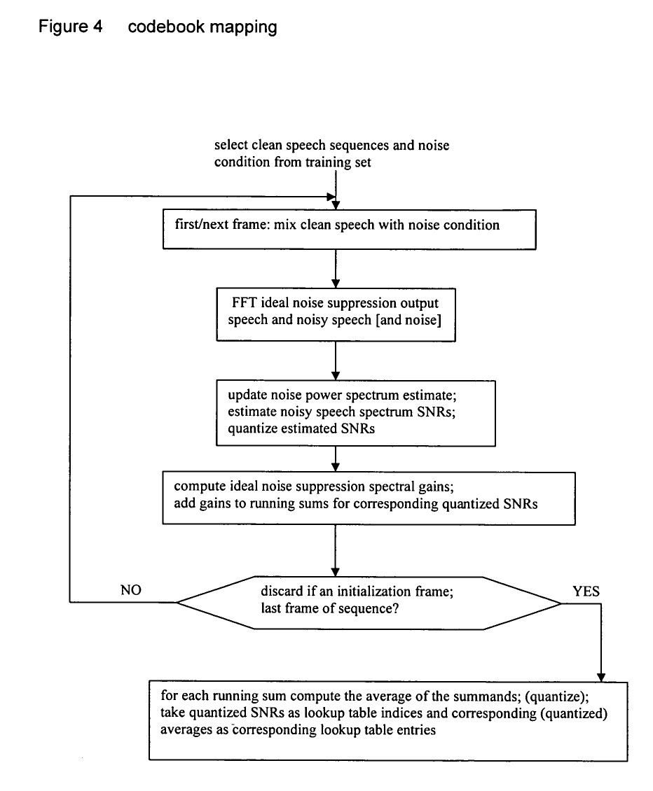

Preferred embodiment methods to construct the gain lookup table (and thus gain curves as in FIGS. 2-3 by interpolation) are essentially codebook mapping methods (generalized vector quantization). FIG. 4 illustrates a first preferred embodiment construction method which proceeds as follows.

First, select a training set of various clean digital speech sequences plus various digital noise conditions (sources and powers). Then, for each sequence of clean speech, s(n), mix in a noise condition, w(n), to give a corresponding noisy sequence, y(n), and for each frame (excluding some initialization frames) in the sequence successively compute the pairs (ρ(k, r), G_{ideal}(k, r)) by iterating the following steps (a)-(e). Lastly, cluster (quantize) the computed pairs to form corresponding (mapped) codebooks and thus a lookup table.

(a) For a frame of the noisy speech compute the spectrum, Y(k, r), where r denotes the frame, and also compute the spectrum of the corresponding frame of ideal noise suppression output Y_{ideal}(k, r). Typically, ideal noise suppression output is generated by digitally adding noise to the clean speech, but the added noise level is 20 dB lower than that of noisy speech signal.

(b) For frame r update the noise spectral energy estimate, |Ŵ(k, r)|², as described in the foregoing; initialize |Ŵ(k, r)|² with the frame energy during an initialization period (e.g., 60 ms).

(c) For frame r compute the SNR for each frequency index, ρ(k, r), as previously described: ρ(k, r)=|Y(k, r)|²/|Ŵ(k, r)|².

(d) For frame r compute the ideal gain for each frequency index, G_{ideal}(k, r), by G_{ideal}(k,r)=|Y_{ideal}(k, r)|/|Y(k, r)|.

(e) Repeat steps (a)-(d) for successive frames of the sequence. The resulting set of pairs (ρ(k, r), G_{ideal}(k, r)) from the training set are the data to be clustered (quantized) to form the mapped codebooks and lookup table.

One simple approach first quantizes the ρ(k, r) (defines an SNR codebook) and then for each quantized ρ(k, r) defines the corresponding G(k,r) by just averaging all of the G_{ideal}(k,r) which were paired with μ(k, r)s that give the quantized ρ(k, r). This averaging can be implemented by adding the G_{ideal}(k,r)s computed for a frame to running sums associated with the quantized ρ(k, r)s. This set of G(k,r)s defines a gain codebook mapped from the SNR codebook. For the example of FIG. 2, quantize ρ(k, r) by rounding off log ρ(k, r) to the nearest 0.1 (1 dB) to give Q(ρ(k,r)). Then for each Q(ρ(k,r)), define the corresponding lookup table entry, lookup{Q(ρ(k,r))}, as the average from the running sum; this minimizes the mean square errors of the gains and completes the lookup table.

Note that graphing the resulting set of points defining the lookup table and connecting the points (interpolating) with a curve yields a suppression curve as in FIG. 2. The particular training set for FIG. 2 was eight speakers of eight languages (English, French, Chinese, Japanese, German, Finnish, Spanish, and Russian) recording twelve sentences each and mixed with four diverse noise sources (train, airport, restaurant, and babble) to generate the noisy speech; the noise SNR is about 10 dB, which insures multiple data points throughout the log ρ(k, r) range of 0-30 dB used for FIG. 2. The noise SNR of ideal noise suppression speech is 30 dB, which is 20 dB lower than noise SNR of noisy speech.

With speech sampled at 8 kHz, a standard 20 ms frame has 160 samples, so N=256 could be used as a convenient block length for FFT.

4. Smoothing Over Time

Further preferred embodiment noise suppression methods provide a smoothing in time, this can help suppress artifacts such as musical noise. A first preferred embodiment extends the foregoing lookup table which has one index (current frame quantized input-signal SNR) to a lookup table with two indices (current frame quantized input-signal SNR and prior frame output-signal SNR); this allows for an adaptive noise suppression curve as illustrated by the family of curves in FIG. 3. In particular, as a lookup table second index take a quantization of the product of the prior frame's gain multiplied by the prior frame's input-signal SNR. FIG. 3 illustrates such a two-index lookup table with one index (quantized log ρ(k, r)) along the horizontal axis and the second index (quantized log(G(k, r−1))+log(ρ(k, r−1))) the label for the curves. The codebook mapping training can use the same training set and have steps analogous to the prior one-index lookup table construction; namely:

(a) For a frame of the noisy speech compute the spectrum, Y(k, r), where r denotes the frame, and also the compute the spectrum of the corresponding frame of ideal noise suppression output Y_{ideal}(k, r).

(b) For frame r update the noise spectral energy estimate, ↑Ŵ(k, r)|², as described in the foregoing; initialize |Ŵ(k, r)|² with frame energy during initialization period (e.g. 60 ms).

(c) For frame r compute the SNR for each frequency index, ρ(k, r), as previously described: ρ(k, r)=|Y(k, r)|²/|Ŵ(k, r)|².

(d) For frame r compute the ideal gain for each frequency index, G_{ideal}(k, r), by G_{ideal}(k,r)²=↑S(k, r)|²/|Y(k, r)|².

(e) For frame r compute the products G_{ideal}(k, r)p(k, r) and save in memory for use with frame r+1.

(f) Repeat steps (a)-(e) for successive frames of the sequence.

The resulting set of triples (ρ(k, r), G_{ideal}(k, r−1)ρ(k, r−1), G_{idea}(k,r)) for the training set are the data to be clustered (quantized) to form the codebooks and lookup table; the first two components relate to the indices for the lookup table, and the third component relates to the corresponding lookup table entry. A preferred embodiment illustrated in FIG. 3 quantizes ρ(k, r) by rounding off log ρ(k, r) to the nearest 0.1 (1 dB) and quantizes G_{ideal}(k, r−1)ρ(k, r−1) by rounding off log [G_{ideal}(k, r−1)ρ(k, r−1)] to the nearest 0.5 (5 dB) to be the two lookup table indices (first codebook), and defines the lookup table (and mapped codebook) entry G(k,r) indexed by the pair (quantized ρ(k, r), quantized G_{ideal}(k, r−1)ρ(k, r−1)) as the average of all of the G_{ideal}(k, r) in triples with the corresponding ρ(k, r) and G_{ideal}(k, r−1)ρ(k, r−1). Again, this may be implemented as the frames are being analyzed by adding each G_{ideal}(k,r) to a running sum for the corresponding index pair. Thus the two-index lookup table amounts to a mapping of the codebook for the pairs (SNR, prior-frame-output) to a codebook for the gain.

FIG. 3 shows that the suppression curve depends strongly upon the prior frame output. If the prior frame output was very small, then the current suppression curve is aggressive; whereas, if the proir frame output was large, then the current frame suppression is very mild.

Alternative smoothing over time approaches do not work as well. For example, simply use the single index lookup table for the current frame gains G(k, r) and define smoothed current frame gains Gₛₘₒₒₜₕ(k, r) by:
Gₛₘₒₒₜₕ(k, r)=αGₛₘₒₒₜₕ(k, r−1)+(1−α)G(k, r)
where α is a weighting factor (e.g. α=0.9). However, this directly applying smoothing to the gain would reduce the time resolution of the gain, and as a result, it would cause echo-like artifacts in noise-suppressed output speech.
5. Clamping

Further preferred embodiment methods modify the gain G(k, r) by clamping it to reduce gain variations during background noise fluctuation. In particular, let Gₘᵢₙ be a minimum for the gain (for example, take log Gₘᵢₙ to be something like −12 dB), then clamp G(k,r) by the assignment:
G(k, r)=max{Gₘᵢₙ, G(k, r)}
6. Voice Detection

Further noise suppression preferred embodiments minimize additional variations in the processed background noise by inclusion of a simple voice-activity detector (VAD), which may be based on signal energy and long-run background noise energy alone. For example, let Eₙₒᵢₛₑ(r)=Σ_{0≦k≦N-1}|Ŵ(k, r)|² be the frame r estimated noise energy, let E_{fr}(r)=Σ_{0≦k≦N-1}|Y(k, r)|² be the frame r signal energy, and let Eₛₘ(r)=Σ_{0≦i≦1} λⱼ Eⱼᵣ(r-j) be the frame signal energy smoothed over J+1 frames, then if Eₛₘ(r)−Eₙₒᵢₛₑ(r) is less than a threshold, deem frame r to be noise. When the input frame r is declared to be noise, increase the noise power estimate for each frequency index, |Ŵ(k, r)|², by 5 dB (e.g., multiply by 3.162) prior to computing the input SNR. This increases the chances that the noise suppression gain will reach the minimum value (e.g., Gₘᵢₙ) for background noise.

7. Alternative Transform with MDCT

The foregoing preferred embodiments transformed to the frequency domain using short-time discrete Fourier transform with overlapping windows, typically with 50% overlap. This requires use of 2N-point FFT, and also needs a 4N-point memory for spectrum data storage (twice the FFT points due to the complex number representation), where N represents the number of input samples per processing frame. The modified DCT (MDCT) overcomes this high memory requirement.

In particular, for time-domain signal x(n) at frame r where the rth frame consists of samples with rN≦n'(r+1)N−1, the MDCT transforms x(n) into X(k,r), k=0, 1, . . . , N−1, defined as:

$$X ( k , r ) = {\sum }_{m = 0}^{2 N - 1} x ( rN + m ) h ( m ) cos \frac{( 2 m + N + 1 ) ( 2 k + 1 ) π}{4 N} ,$$

where h(m), m=0, 1, . . . , 2N−1, is the window function. The transform is not directly invertible, but two successive frames provide for inversion; namely, first compute:

$${x}^{′} ( m , r ) = \frac{2}{N} h ( m ) {\sum }_{k = 0}^{N - 1} X ( k , r ) cos \frac{( 2 m + N + 1 ) ( 2 k + 1 ) π}{4 N}$$

Then reconstruct the rth frame by requiring
x(rN+m)=x′(m+N, r−1)+x′(m, r) for m=0, 1, . . . , N−1.
This becomes the well-known adjacent window condition for h(m):
h(m)²+h(m+N)²=1 for m=0, 1, . . . , N−1.
A commonly used window is: h(m)=sin [π(2m+1)/2N].

Thus the FFTs and IFFTs in the foregoing and in FIGS. 1a-1b could be replaced by MDCTs and two-frame inverses.

8. Modifications

The preferred embodiments can be modified while retaining one or more of the features of spectral amplitude gain filtering determined by signal-to-noise estimation and codebook mapping (lookup table).

For example, the various parameters and thresholds could have different values or be adaptive. The quantization for the lookup table and codebooks could be other than uniform in logs, other parameters could define the second (or a third) index for the lookup table, such as averages over K prior frames of the output, and so forth; smaller lookup tables could be generated by subsampling with averaging of larger lookup tables. The transform to a frequency domain may be by other transforms, such as DCT, finite integer, and so forth. The codebook mapping (lookup table construction) could use differing inputs (different languages, length of sentences, noise conditions, et cetera) and the amount and type of noise added to clean speech to yield ideal speech could be varied.

What is claimed is:

1. A method of noise suppression, comprising:
(a) transforming a block of input speech to a frequency domain;
(b) for each frequency, estimating the signal-to-noise ratio of said transformed speech;
(c) for said each frequency, multiplying said transformed speech by a gain factor, where said gain factor is from a lookup table indexed by a quantization of said estimated signal-to-noise ratio from (b);
(d) inverse transforming the products of the multiplyings from (c);
(e) repeating (a)-(d) for successive blocks of input speech; and
(f) combining the results of (e).

2. The method of claim 1, wherein:
(a) said estimating a signal-to-noise ratio of (b) of claim 1 uses a noise spectrum estimate updated by upward and downward time constants.

3. The method of claim 1, wherein:
(a) said blocks of input speech overlap and include windowing.

4. The method of claim 1, wherein:
(a) sid lookup table is also indexed by a quantization of the gain and estimated signal-to-noise ratio of a prior block of input speech.

5. The method of claim 1, wherein:
(a) said gain is clamped by a minimum gain.

6. The method of claim 1, further comprising:
(a) detecting voice activity in said block of input speech; and
(b) when said detection indicates no speech, increment a noise spectrum estimate for said estimating a signal-to-noise ratio of (b) of claim 1.

7. A noise suppressor, comprising:
(a) a transformer for an input block of noisy speech;
(b) a noise spectrum estimator coupled to said transformer;
(c) a signal-to-noise estimator coupled to said noise spectrum estimator and to said transformer;
(d) a gain lookup table with input coupled to said signal-to-noise estimator, said gain lookup table contents being a codebook mapping from signal-to-noise ratio codebook to gain codebook and constructed from a training set of speech and noise conditions;
(e) a multiplier coupled to said transformer and to an output of said gain lookup table; and
(f) an inverse transformer coupled to an output of said multiplier.

8. The noise suppressor of claim 7, further comprising:
(a) a memory for prior block estimated signal-to-noise ratio and prior block ideal gain, said memory coupled to said signal-to-noise estimator and to said lookup table; and
(b) wherein said gain lookup table includes a second input for said memory contents.

9. The noise suppressor of claim 7, wherein:
(a) said noise spectrum estimator and said signal-to-noise estimator are implemented as programs on a programmable processor.

10. A method of noise suppression codebook mapping, comprising:
(a) providing a training set of speech and noise conditions mixed to give noisy speech and corresponding ideal (noise-suppressed) speech;
(b) transforming both a block of noisy speech and a corresponding block of ideal speech to a frequency domain;
(c) for each frequency, estimating the signal-to-noise ratio of said transformed noisy speech;
(d) for said each frequency, computing an ideal gain from said transformed noise speech and said transformed ideal speech;
(e) repeating (b)-(d) for successive blocks;
(f) clustering the results of (e) to define a codebook mapping from estimated signal-to-noise to ideal gain.

11. The method of claim 10, wherein:
(a) said clustering is by
(i) quantizing said estimated signal-to-noise results from said repeated (c) of claim 10 to define a codebook for estimated signal-to-noise ratio; and
(ii) for each quantization from (i), averaging said results from repeated (d) of claim 10 which correspond to said estimated signal-to-noise results of said repeated (c) of claim 1 for said each quantization to define a gain codebook and a mapping from said codebook for estimated signal-to-noise ratio.

12. The method of claim 10, further comprising:
(a) after said (d) and before said (e) of claim 10, for said each frequency computing the product of said estimated signal-to-noise ratio multiplied by said ideal gain from a prior block;
(b) modifying said (e) of claim 10 to include foregoing (a); and
(c) wherein said (f) of claim 10 codebook mapping also maps from prior block product of estimated signal-to-noise ratio multiplied by ideal gain.
